(19) United States
(12) Patent Application Publication
(10) Pub. No.: US 2013/0082928 A1
(43) Pub. Date: Apr. 4, 2013

(54) KEYBOARD-BASED MULTI-TOUCH INPUT SYSTEM USING A DISPLAYED REPRESENTATION OF A USERS HAND

(71) Applicants: Seung Wook Kim, Cupertino, CA (US); Eric Liu, Santa Clara, CA (US); Stefan J. Marti, Santa Clara, CA (US)

(72) Inventors: Seung Wook Kim, Cupertino, CA (US); Eric Liu, Santa Clara, CA (US); Stefan J. Marti, Santa Clara, CA (US)

(21) Appl. No.: 13/249,421

(22) Filed: Sep. 30, 2011

(51) Int. Cl. G06F 3/02

(52) U.S. Cl. 345/168

(57) ABSTRACT

Example embodiments relate to a keyboard-based multi-touch input system using a displayed representation of a user's hand. In example embodiments, a sensor detects movement of a user's hand in a direction parallel to a top surface of a physical keyboard. A computing device may then receive information describing the movement of the user's hand from the sensor and output a real-time visualization of the user's hand on the display. This visualization may be overlaid on a mufti-touch enabled user interface, such that the user may perform actions on objects within the user interface by performing multi-touch gestures.

### BACKGROUND

As computing devices have developed, a significant amount of research and development has focused on improving the interaction between users and devices. One prominent result of this research is the proliferation of touch-enabled devices, which allow a user to directly provide input by interacting with a touch-sensitive display using the digits of his or her hands. By eliminating or minimizing the need for keyboards, mice, and other traditional input devices, touch-based input allows a user to control a device in a more intuitive manner.

### BRIEF DESCRIPTION OF THE DRAWINGS

The following detailed description references the drawings, wherein:

FIG. 1A is a diagram of an example apparatus for enabling a user to interact with a keyboard to provide multi-touch input to a touch-enabled interface, the apparatus including a camera integrated into a display;

FIG. 1B is a diagram of an example apparatus for enabling a user to interact with a keyboard to provide multi-touch input to a touch-enabled interface, the apparatus including a camera mounted on the keyboard;

FIG. 2 is a block diagram of an example apparatus including a computing device, keyboard, sensor, and display device for enabling multi-touch input using the keyboard;

FIG. 3 is a block diagram of an example apparatus for enabling multi-touch input using a keyboard, the apparatus outputting a visualization of a user's hand with applied graphical effects and enabling navigation within a multi-layered touch interface;

FIG. 4 is a flowchart of an example method for receiving multi-touch input using a keyboard;

FIG. 5 is a flowchart of an example method for receiving multi-touch input using a keyboard to interact with a multi-layered touch user interface;

FIG. 6 is a diagram of an example interface for applying a regioning effect to a visualization of a user's hand;

FIGS. 7A-7D are diagrams of example interfaces for applying a revealing effect to a visualization of a user's hand; and

FIGS. 8A & 8B are diagrams of example interfaces for applying physics effects to user interface elements based on collisions with a visualization of a user's hand.

### DETAILED DESCRIPTION

As detailed above, touch-sensitive displays allow a user to provide input to a computing device in a more natural manner. Despite its many benefits, touch-based input can introduce difficulties depending on the configuration of the system. For example, in some configurations, a user interacts with a keyboard to provide typed input and interacts directly with a touch-enabled display to provide touch input. In such configurations, the user must frequently switch the placement of his or her hands between the keyboard and the touch display, often making it inefficient and time-consuming to provide input. These configurations are also problematic when the touch display is in a location that it is beyond the reach of the user, such as a situation where the user is viewing and/or listening to multimedia content at a distance from the display.

In other configurations, the display device may not support touch interaction. For example, most televisions and personal computer displays lack hardware support for touch and are therefore unsuitable for use in touch-based systems. As a result, a user of such a display device is unable to take advantage of the many applications and operating systems that are now optimized for touch-based interaction.

Example embodiments disclosed herein address these issues by allowing a user to interact with a physical keyboard that provides conventional keyboard input and the additional capability for multi-touch input. For example, in some embodiments, a sensor detects movement of a user's hand in a direction parallel to a top surface of a physical keyboard. A computing device may then receive information describing the movement of the user's hand from the sensor and output a real-time visualization of the user's hand on the display. This visualization may be overlaid on a multi-touch enabled user interface, such that the user may perform actions on objects within the user interface by performing multi-touch gestures involving the movement of multiple digits on or above the top surface of the keyboard.

In this manner, example embodiments disclosed herein allow a user to interact with a touch-enabled system using a physical keyboard, thereby reducing or eliminating the need for a display that supports touch input. Furthermore, example embodiments enable a user to provide multi-touch input using multiple digits, such that the user may fully interact with a multi-touch interface using the keyboard, Still further, because additional embodiments allow for navigation between layers of a touch interface, the user may seamlessly interact with a complex, multi-layered touch interface using the keyboard.

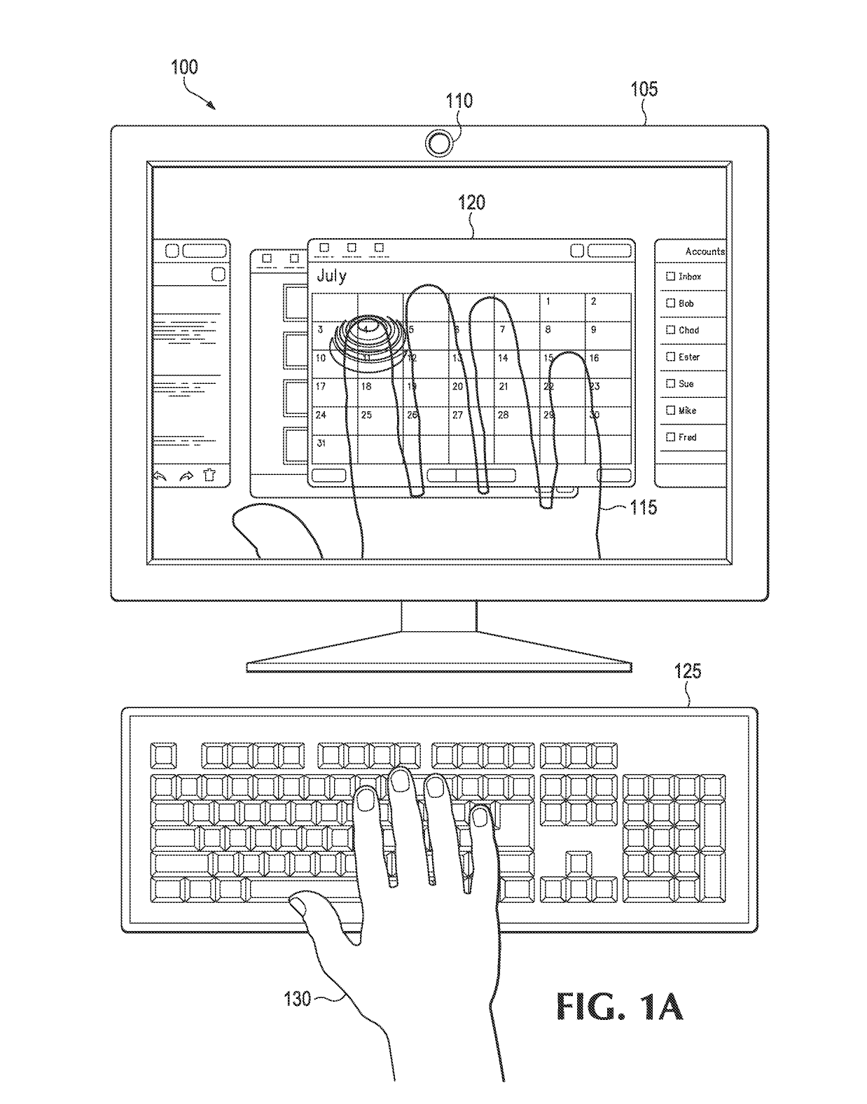

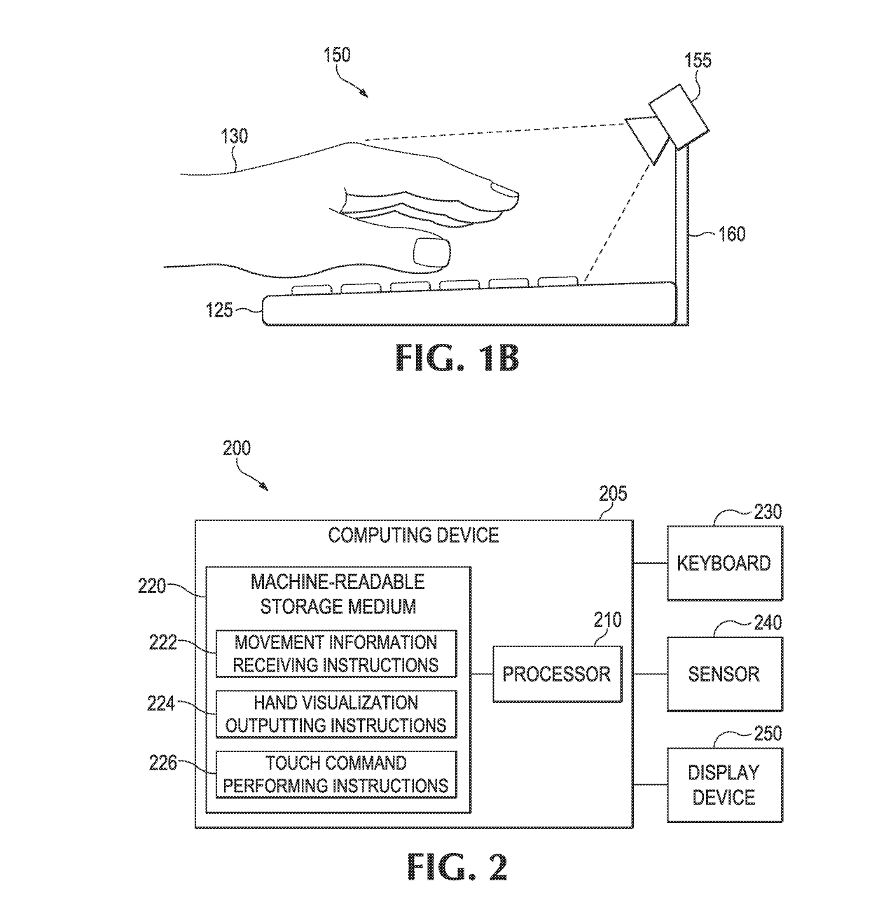

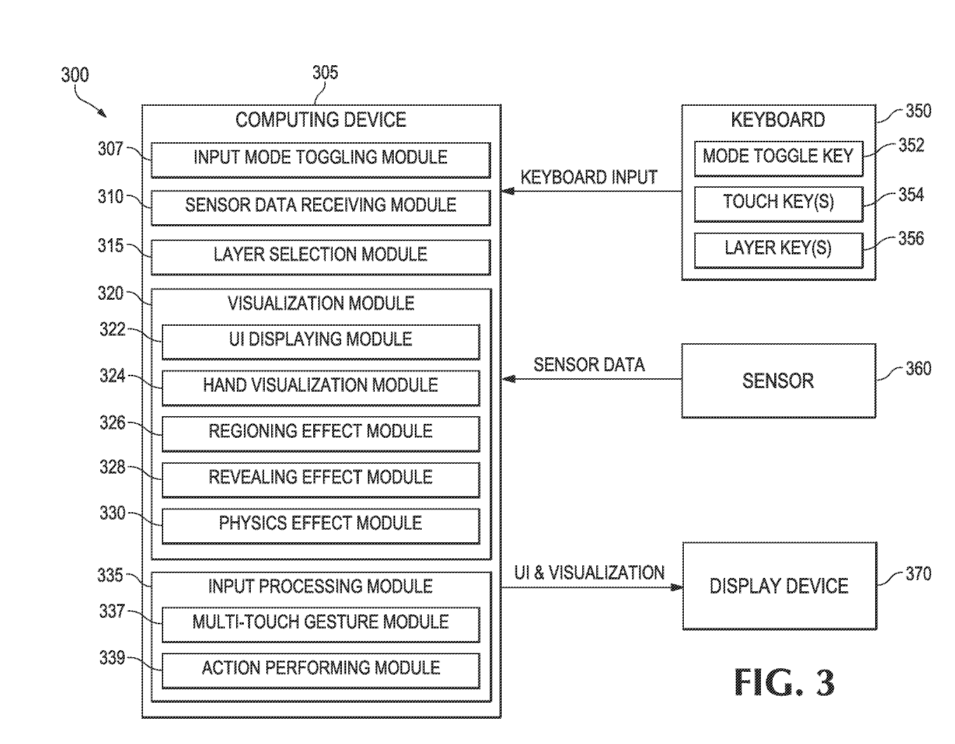

Referring now to the drawings, FIG. 1A is a diagram of an example apparatus 100 for enabling a user to interact with a keyboard 125 to provide multi-touch input to a touch-enabled interface, the apparatus including a camera 110 integrated into a display 105. The following description of FIGS. 1A and 1B provides an overview of example embodiments disclosed herein. Further implementation details regarding various embodiments are provided below in connection with FIGS. 2 through 8.

As depicted in FIG. 1A, a display 105 includes a camera 110, which may be a camera with a wide-angle lens integrated into the body of display 105. Furthermore, camera 110 may be pointed in the direction of keyboard 125, such that camera 110 observes movement of the user's hand 130 in a plane parallel to the top surface of keyboard 125. It should be noted, however, that a number of alternative sensors for tracking movement of the user's hands may be used, as described in further detail below in connection with FIG. 2.

Display 105 may be coupled to a video output of a computing device (not shown), which may generate and output a multi-touch interface on display 105. To enable a user to interact with the objects 120 displayed in the multi-touch interface, camera 110 detects the user's hand 130 on or above the top surface of the keyboard. The computing device then uses data from camera 110 to generate a real-time visualization 115 of the user's hand for output on display 105. For example, as the user moves his or her hand or hands 130 along or above the surface of keyboard 125, camera 110 provides captured data to the computing device, which translates the position of the user's hand(s) on keyboard 125 to a position within the user interface. The computing device may then generate the visualization 115 of the user's hand(s) 130 using the camera data and output the visualization overlaid on the displayed user interface at the determined position.

The user may then perform touch commands on the objects 120 of the user interface by moving his or her hands and/or digits with respect to the top surface of keyboard 125. For example, the user may initiate a touch event by, for example, depressing one or more keys in proximity to one of his or her digits, pressing a predetermined touch key (e.g,. the CTRL key), or otherwise applying pressure to the surface of keyboard 125 without actually depressing the keys. Here, as illustrated, the user activated a touch of the right index finger, which is reflected in hand visualization 115 as a touch of the right index finger on the calendar interface. Because camera 110 detects movement of the user's entire hand, including all digits, the user may then perform a gesture by moving one or more digits along or above the top surface of keyboard 125.

The computing device may then use the received camera data to translate the movement of the user's digits on keyboard 125 into a corresponding touch command at a given position within the multi-touch user interface. For example, in the illustrated example, swiping the finger upward could close the calendar application, while swiping leftward could scroll to the card on the right, which is currently depicting an accounts application. As an example of a multi-touch gesture, the user could perform a pinching gesture in which the thumb is moved toward the index finger to trigger a zoom function that zooms out the view with respect to the currently-displayed objects 120 in the touch interface. In embodiments that use a sensor other than a camera, apparatus 100 may similarly detect and process gestures using data from the sensor.

FIG. 1B is a diagram of an example apparatus 150 for enabling a user to interact with a keyboard 125 to provide multi-touch input to a touch-enabled interface, the apparatus 150 including a camera 155 mounted on the keyboard 125. In contrast to apparatus 100 of FIG. 1A, apparatus 150 may instead include camera 155 with a wide-angle lens mounted to a boom 160, such that camera 155 is pointed downward at the surface of keyboard 125.

The mechanism for mounting camera 155 to keyboard 125 may vary by embodiment. For example, in some embodiments, boom 160 may be a fixed arm attached to either a top or rear surface of keyboard 155 in an immovable position. Alternatively, boom 160 may be movable between an extended and retracted position. As one example of a movable implementation, boom 160 may be a hinge coupling the camera 155 to a rear or top surface of keyboard 155. Boom 160 may thereby move camera 155 between an extended position in which boom 160 is perpendicular to the top surface of keyboard 125 and a retracted position in which boom 160 is substantially parallel to the top surface of keyboard 125 and/or hidden inside the body of keyboard 125. In another implementation, boom 160 may be a telescoping arm that extends and retracts. In implementations with a movable boom 160, movement of camera 155 between the two positions may be triggered by activation of a predetermined key on keyboard 125 (e.g., a mode toggle key on the keyboard), a button, a switch, or another activation mechanism. Upon selection of the activation mechanism when camera 155 is in the retracted position, boom 160 may rise to the extended position using a spring-loaded mechanism, servo motor, or other mechanism. The user may then return boom 160 to the retracted position either manually or automatically based on a second activation of the predetermined key, button, switch, or other mechanism.

Regardless of the mechanism used to mount and move camera 155, the camera 155 may be pointed at the surface of keyboard 125 and may thereby capture movement of the user's hands along or above the top surface of keyboard 125. Thus, as described above in connection with FIG. 1A, a coupled computing device may generate a visualization of the user's hands and/or digits and output the visualization on a display overlaid on a touch-enabled interface.

FIG. 2 is a block diagram of an example apparatus 200 including a computing device 205, a keyboard 230, a sensor 240, and a display device 250 for enabling mufti-touch input using the keyboard 230. As described in further detail below, a sensor 240 may detect movement of a user's hands and/or digits parallel to a top surface of keyboard 230 and provide data describing the movement to computing device 205. Computing device 205 may then process the received sensor data, generate a visualization of the user's hand(s), output the interface and overlaid hand visualization on display device 250, and subsequently perform any touch commands received from the user on objects displayed within the interface.

Computing device 205 may be, for example, a notebook computer, a desktop computer, an all-in-one system, a tablet computing device, a mobile phone, a set-top box, or any other computing device suitable for display of a touch-enabled interface on a coupled display device 250. In the embodiment of FIG. 2, computing device 205 may include a processor 210 and a machine-readable storage medium 220.

Processor 210 may be one or more central processing units (CPUs), semiconductor-based microprocessors, and/or other hardware devices suitable for retrieval and execution of instructions stored in machine-readable storage medium 220. Processor 210 may fetch, decode, and execute instructions 222, 224, 226 to process data from sensor 240 to display a visualization of the user's hand and perform any detected touch commands, As an alternative or in addition to retrieving and executing instructions, processor 210 may include one or more integrated circuits (ICs) or other electronic circuits that include electronic components for performing the functionality of one or more of instructions 222, 224, 226.

Machine-readable storage medium 220 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage device, an optical disc, and the like. As described in detail below, machine-readable storage medium 220 may be encoded with a series of executable instructions 222, 224, 226 for receiving data from sensor 240, processing the sensor data to generate a visualization of the user's hand, and performing touch commands based on the position of the visualization within the touch interface.

Movement information receiving instructions 222 may initially receive information describing the movement of the user's hand and/or digits from sensor 240. The received information may be any data that describes movement of the user's hands and/or digits with respect to keyboard 230. For example, in embodiments in which sensor 240 is a camera, the received movement information may be a video stream depicting the user's hands with respect to the underlying keyboard surface. As another example, in embodiments in which sensor 240 is a capacitive, infrared, electric field, or ultrasound sensor, the received movement information may be a “heat” image detected based on the proximity of the user's hands to the surface of keyboard 230. Other suitable data formats will be apparent based on the type of sensor 240.

Upon receipt of the information describing the movement of the user's hands and/or digits, hand visualization outputting instructions 224 may generate and output a real-time visualization of the user's hands and/or digits. This visualization may be overlaid on the touch-enabled user interface currently outputted on display device 250, such that the user may simultaneously view a simulated image of his or her hand and the underlying touch interface. FIG. 1A illustrates an example hand visualization 115 overlaid on a multi-touch user interface.

Depending on the type of sensor 240, hand visualization outputting instructions 224 may first perform image processing on the sensor data to prepare the visualization for output. For example, when sensor 240 is a camera, outputting instructions 224 may first isolate the image of the user's hand within the video data by, for example, subtracting an initial background image obtained without the user's hand in the image. As an alternative, instructions 224 may detect the outline of the user's hand within the camera image based on the user's skin tone and thereby isolate the video image of the user's hand. In addition or as another alternative, feature tracking and machine learning techniques may be applied to the video data for more precise detection of the user's hand and/or digits. When sensor 240 is a capacitive or infrared touch sensor, the received sensor data may generally reflect the outline of the user's hand, but outputting instructions 224 may filter out noise from the raw hand image to acquire a cleaner visualization. Finally, when sensor 240 is an electric field or ultrasound sensor, outputting instructions 224 may perform an edge detection process to isolate the outline of the user's hand and thereby obtain the visualization.

After processing the image data received from sensor 240, outputting instructions 224 may then determine an appropriate position for the visualization within the displayed touch interface. For example, the sensor data provided by sensor 240 may also include information sufficient to determine the location of the user's hands with respect to keyboard 230. As one example, when sensor 240 is a camera, instructions 224 may use the received video information to determine the relative location of the user's hand with respect to the length and width of keyboard 230. As another example, when sensor 240 is embedded within keyboard 230, the sensor data may describe the position of the user's hand on keyboard 230, as, for example, a set of coordinates.

After determining the position of the user's hand with respect to keyboard 230, outputting instructions 224 may translate the position to a corresponding position within the touch interface. For example, outputting instructions 224 may utilize a mapping table to translate the position of the user's hand with respect to keyboard 230 to a corresponding set of X and Y coordinates in the touch interface. Outputting instructions 224 may then output the visualization of the user's left hand and/or right hand within the touch interface. When sensor 240 is a camera, the visualization may be a real-time video representation of the user's hands. Alternatively, the visualization may be a computer-generated representation of the user's hands based on the sensor data. In addition, depending on the implementation, the visualization may be opaque or may instead use varying degrees of transparency (e.g., 75% transparency, 50% transparency, etc.). Furthermore, in some implementations, outputting instructions 224 may also apply stereoscopic effects to the visualization, such that the hand visualization has perceived depth when display 250 is 3D-enabled.

Touch command performing instructions 226 may then perform touch commands on objects displayed within the touch interface based on the movement of the user's hand and/or digits detected by sensor 240 and based on the position of the hand visualization within the touch interface. Performing instructions 226 may monitor for input on keyboard 230 corresponding to a touch event. For example, when sensor 240 is a camera, electric field sensor, or ultrasound sensor, depression of a key on keyboard 230 may represent a touch event equivalent to a user directly touching the touch interface with a particular digit.

The key or keys used for detection of a touch event may vary by embodiment, For example, in some embodiments, the CTRL key, ALT key, spacebar, or other predetermined keys may each trigger a touch event corresponding to a particular digit (e.g., CTRL may activate a touch of the index finger, ALT may activate a touch of the middle finger, the spacebar may activate a touch of the thumb, etc.). As another example, the user may depress any key on keyboard 230 for a touch event and thereby trigger multiple touch events for different digits by depressing multiple keys simultaneously. In these implementations, the digit for which the touch is activated may be determined with reference to the sensor data to identify the closest digit to each activated key. In some of these implementations, a particular key may be held and released to switch between touch and text events, respectively. For example, depressing and holding a predetermined key (e.g., CTRL) may indicate that the user desires to enter touch mode, such that subsequent presses of one or more keys on the keyboard activate touch or multi-touch events. The user may then release the predetermined key to return to text mode, such that the user may continue typing as usual. Alternatively, when sensor 240 is a capacitive or infrared touch sensor embedded within keyboard 230, the user may also or instead trigger touch events by simply applying pressure to the surface of the keys without actually depressing the keys. In such implementations, the digit(s) for which a touch event is activated may be similarly determined with reference to the sensor data.

Subsequent to detection of one or more touch events, performing instructions 226 may track the movement of the digit or digits corresponding to the touch event, For example, when the user has provided input representing a touch of the index finger, performing instructions 226 may track the movement of the user's index finger based on the data provided by sensor 240. Similarly, when the user has provided input representing a touch of multiple digits (e.g., the index finger and thumb), performing instructions 226 may track the movement of each digit. Performing instructions 226 may continue to track the movement of the user's digit or digits until the touch event terminates. For example, the touch event may terminate when the user releases the depressed key or keys, decreases the pressure on the surface of keyboard 230, or otherwise indicates the intent to deactivate the touch for his or her digit(s).

As an example, suppose the user initially activated a multi-touch command by simultaneously pressing the “N” and “9” keys with the right thumb and index finger, respectively. The user may activate a multi-touch command corresponding to a pinching gesture by continuing to apply pressure to the keys, while moving the thumb and finger together, such that the “J” and “I” keys are depressed. Performing instructions 226 may detect the initial key presses and continue to monitor for key presses and movement of the user's digits, thereby identifying the pinching gesture. Alternatively, the user may initially activate the multi-touch command by depressing and releasing multiple keys and the sensor (e.g., a camera) may subsequently track movement of the user's fingers without the user pressing additional keys. Continuing with the previous example, simultaneously pressing the “N” and “9” keys may activate a multi-touch gesture and the sensor may then detect the movement of the users fingers in the pinching motion.

As the user is moving his or her digits, touch command performing instructions 226 may identify an object in the interface with which the user is interacting and perform a corresponding action on the object. For example, performing instructions 226 may identify the object at the coordinates in the interface at which the visualization of the corresponding digit(s) is located when the user initially triggers one or more touch events. Performing instructions 226 may then perform an action on the object based on the subsequent movement of the user's digit(s), For example, when the user has initiated a touch event for a single finger and moved the finger in a lateral swiping motion, performing instructions 226 may scroll the interface horizontally, select a next item, move to a new “card” within the interface, or perform another action. As another example, when the user has initiated a multi-touch event involving multiple fingers, performing instructions 226 may perform a corresponding multi-touch command by, for example, zooming out in response to a pinch gesture or zooming in based on a reverse pinch gesture. Other suitable actions will be apparent based on the particular multi-touch interface and the particular gesture performed by the user.

Based on repeated execution of instructions 222, 224, 226, computing device 205 may continuously update the real-time visualization of the user's hands within the touch interface, while simultaneously processing any touch or multi-touch gestures performed by the user. In this manner, the user may utilize the hand visualization overlaid on a multi-touch interface displayed on display device 250 to simulate direct interaction with the touch interface.

Keyboard 230 may be a physical keyboard suitable for receiving typed input from a user and providing the typed input to a computing device 205, As described above, the user may also interact with keyboard 230 to provide touch gestures to computing device 205 without interacting directly with display device 250. In particular, the user may activate one or more keys of keyboard 230 to initiate a touch or multi-touch command. After activating the keys, the user may then move his or her hand and/or digits parallel to the top surface of the keyboard to specify the movement used in conjunction with a touch or mufti-touch command.

Sensor 240 may be any hardware device or combination of hardware devices suitable for detecting movement of a user's hands and digits in a direction parallel to a top surface of keyboard 230, in particular, sensor 240 may detect movement of the user's hands and digits directly on the top surface of keyboard 230 and/or above the surface of keyboard 230. As described above, sensor 240 may then provide sensor data to computing device 205 for generation of a hand visualization and execution of touch and multi-touch commands.

In some implementations, sensor 240 may be a device physically separate from keyboard 230. For example, sensor 240 may be a camera situated above the surface of keyboard 230 and pointed in a direction such that the camera observes the movement of the user's hands with respect to the top surface of keyboard 230. In these implementations, a visual marker may be included on keyboard 230, such that the camera may calibrate its position by detecting the visual marker. When using a camera to detect movement of the user's hands, apparatus 200 may utilize key presses on keyboard 230 to identify touch events, while using the captured video image as the real-time visualization of the user's hands. In camera-based implementations, the camera may be a 2D red-green-blue (RGB) camera, a 2D infrared camera, a 3D time-of-flight infrared depth sensor, a 3D structured light-based infrared depth sensor, or any other type of camera.

In other implementations, sensor 240 may be incorporated into keyboard 230. For example, sensor 240 may be a capacitive, infrared, resistive, electric field, electromagnetic, thermal, conductive, optical pattern recognition, radar, depth sensing, or micro air flux change sensor incorporated into, on the surface of, or beneath the keys of keyboard 230. In this manner, sensor 240 may detect the user's hands and digits on or above the top surface of keyboard 230 and provide sensor data to computing device 205 for generation of the hand visualization and processing of touch commands. Depending on the type of sensor, apparatus 200 may then utilize key presses on keyboard 230 and/or pressure on the surface of the keys to identify touch events.

Display device 250 may be a television, flat panel monitor, projection device, or any other hardware device suitable for receiving a video signal from computing device 205 and outputting the video signal. Thus, display device 250 may be a Liquid Crystal Display (LCD), a Light Emitting Diode (LED) display, or a display implemented according to another display technology. Advantageously, the embodiments described herein allow for touch interaction with a displayed multi-touch interface, even when display 250 does not natively support touch input.

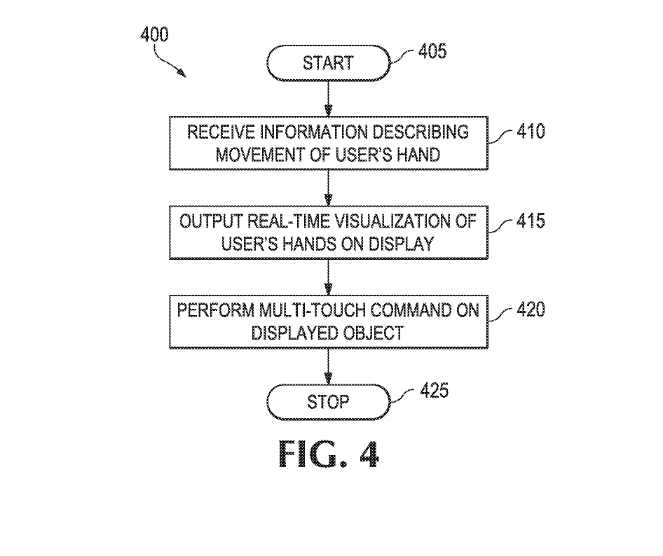

FIG. 3 is a block diagram of an example apparatus 300 for enabling multi-touch input using a keyboard 350, the apparatus 300 outputting a visualization of a user's hand with applied graphical effects and enabling navigation of a mufti-layered touch interface. Apparatus 300 may include computing device 305, keyboard 350, sensor 360 and display device 370.

As with computing device 205 of FIG. 2, computing device 305 may be any computing device suitable for display of a touch-enabled interface on a coupled display device 370. As illustrated, computing device 305 may include a number of modules 307-339 for providing the virtual touch input functionality described herein. Each of the modules may include a series of instructions encoded on a machine-readable storage medium and executable by a processor of computing device 305. In addition or as an alternative, each module may include one or more hardware devices including electronic circuitry for implementing the functionality described below.

Input mode toggling module 307 may allow the user to switch between a mufti-touch mode and a keyboard-only mode in response to a predetermined input. For example, keyboard 350 may include a mode toggle key 352 that enables the user to switch between multi-touch and keyboard modes. In multi-touch mode, the user may move his or her hands on or above the top surface of keyboard 350 and depress the keys of keyboard 350 to activate touch events. In addition, during multi-touch mode, computing device 305 also generates and displays a visualization of the user's hand or hands on display device 370. In contrast, in keyboard-only mode, computing device 305 may stop displaying the real-time visualization and the user may type on the keyboard to provide typewritten input to computing device 305. In implementations in which the sensor is a keyboard-mounted camera, such as apparatus 150 of FIG. 13, activation of mode toggle key 352 may also trigger movement of the camera between the retracted and extended position and vice versa, such that the camera may toggle between the two positions depending on whether keyboard-only mode or touch-mode is currently enabled. In this manner, the user may quickly switch between conventional keyboard use and the enhanced touch functionality described herein.

Sensor data receiving module 310 may receive data from sensor 360 describing the movement of the user's hands and/or digits along or above the top surface of keyboard 350. As detailed above in connection with movement information receiving instructions 222 of FIG. 2, the sensor data may be, for example, a stream of video information, a “heat” image, or any other data sufficient to describe the position and movement of the user's hands with respect to the keyboard.

Layer selection module 315 may allow a user to navigate between layers of the multi-touch interface. In particular, in some implementations, the multi-touch user interface with which the user is interacting may include windows in a plurality of stacked layers. For example, in the interface of FIG. 1A, the user is currently interacting with a calendar application that is stacked on top of a photos application. Layer selection module 315 moves the hand visualization between layers, such that the currently-selected layer is displayed in the foreground of the interface and the user may thereby provide touch input to the selected layer. Continuing with the example of FIG. 1A, layer selection module 315 would allow the user to bring the photos application, the calendar application, or the desktop to the foreground of the user interface.

The method for allowing the user to move the visualization between layers varies by implementation. In some implementations, layer selection module 315 may be responsive to layer key(s) 356, which may be one or more predetermined keys on keyboard 350 assigned to change the currently-selected layer. For example., layer key 356 may be a single key that selects the next highest or lowest layer each time the key is depressed. Thus, repeated selection of layer key 356 would rotate through the layers of the interface, bringing each layer to the foreground of the interface when it is selected. Alternatively, one key may be used to select the next highest layer (e.g., the up arrow key), while another key may be used to select the next lowest layer (e.g., the down arrow key).

In other implementations, layer selection module 315 may be responsive to an indication of the distance of the user's hand or digits from the top surface of keyboard 350. For example, sensor 360 may include the capability of detecting the proximity of the user's hand to the top surface of keyboard 350 and may provide an indication of the proximity to layer selection module 315. In response, layer selection module 315 may then selectively bring a particular layer to the foreground based on the indication of height. Thus, in some implementations, when the user's hand is on the surface of keyboard 350, layer selection module 315 may select the lowest layer in the interface (e.g., the desktop of the interface or the lowest window). Alternatively, the layer selection may be inverted, such that the visualization of the user's hand is displayed on the top layer when the user's hand is on the surface of keyboard 350.

In still further implementations, layer selection module 315 may be responsive to a speed of the movement of the user's hand or digits. For example, layer selection module 315 may use the data from sensor 360 to determine how quickly the user has waved his or her hand on or above the top surface of keyboard 350. Layer selection module 315 may then select a layer based on the speed of the movement. For example, when the user very quickly moved his or her hand, layer selection module 315 may select the lowest (or highest) layer. Similarly, movement that is slightly slower may trigger selection of the next highest (or lowest) layer within the interface.

It should be noted that these techniques for selecting the layer are in addition to any layer selection techniques natively supported by the operating system or application. For example, the operating system may include a taskbar listing all open applications, such that the user may move the hand visualization to the desired application in the taskbar and trigger a touch event to bring that application to the foreground. Similarly, in a card-based operating system such as the one illustrated in FIG. 1A, the user may use the hand visualization to select the revealed edge of a background card to bring that card to the foreground.

Furthermore, the layer selection technique may apply to any multi-layered interface. For example, in the examples given above, the layers are generally referred to as cards or windows stacked on top of one another, but the layer selection technique is equally applicable to any other 2.5-dimensional interface that includes user interface elements stacked on top of one another and that allows a user to navigate between different depths within the interface. In addition, the multi-layered interface may also be a three-dimensional interface in which the user interface is configured as a virtual world with virtual objects serving as user interface objects. For example, the virtual world could be a room with a desk that includes a virtual phone, virtual drawers, virtual stacks of papers, or any other elements oriented within the 3D interface. In each of these examples, layer selection module 315 may allow the user to navigate between user interface elements by moving between various depths within the interlace (e.g., between stacked objects in a 2.5D interface and within the “Z” dimension in a 3D interface)

Regardless of the technique used for selecting layers, a number of visualization techniques may be used to display the current layer in the foreground.

For example, as described further below in connection with UI displaying module 322, the currently-selected layer may be moved to the top of the interface. As another example, the area within the outline of the user's hand may be used to reveal the currently-selected layer within the boundaries of the user's hand. This technique is described further below in connection with revealing effect module 328.

Visualization module 320 may receive sensor data from receiving module 310 and a layer selection from selection module 315 and, in response, output a multi-touch interface and a visualization of the user's hand overlaid on the interface. Thus, module 320 may implemented similarly to hand visualization outputting instructions 224 of FIG. 2, but may include additional functionality described below.

User interface displaying module 322 may be configured to output the multi-touch user interface including objects with which the user can interact. Thus, user interface displaying module 322 may determine the currently-selected layer based on information provided by layer selection module 315. Displaying module 322 may then output the interface with the currently-selected layer in the foreground of the interface. For example, displaying module 322 may display the currently-selected window at the top of the interface, such that the entire window is visible.

Hand visualization module 324 may then output a visual representation of the user's hand or hands overlaid on the multi-touch interface. For example, as described in further detail above in connection with hand visualization outputting instructions 224 of FIG, 2, hand visualization module 324 may generate a real-time visualization of the user's hand or hands, determine an appropriate location for the visualization, and output the visualization on top of the user interface at the determined location.

In implementations in which sensor 360 is a camera, visualization module 320 may perform additional processing prior to outputting the real-time visualization. For example, if the camera includes a fisheye or wide-angle lens, visualization module 320 may first normalize the video representation of the user's hand or hands to reverse a wide-angle effect of the camera. As one example, visualization module may distort the image based on the parameters of the lens to minimize the effect of the wide-angle lens. Additionally, when the camera is not directly overhead, visualization module 324 may also shift the perspective so that the image appears to be from overhead by, for example, streaming the image through a projective transformation tool that stretches portions of the image. Finally, visualization module 320 may output the normalized and shifted video representation of the user's hand or hands.

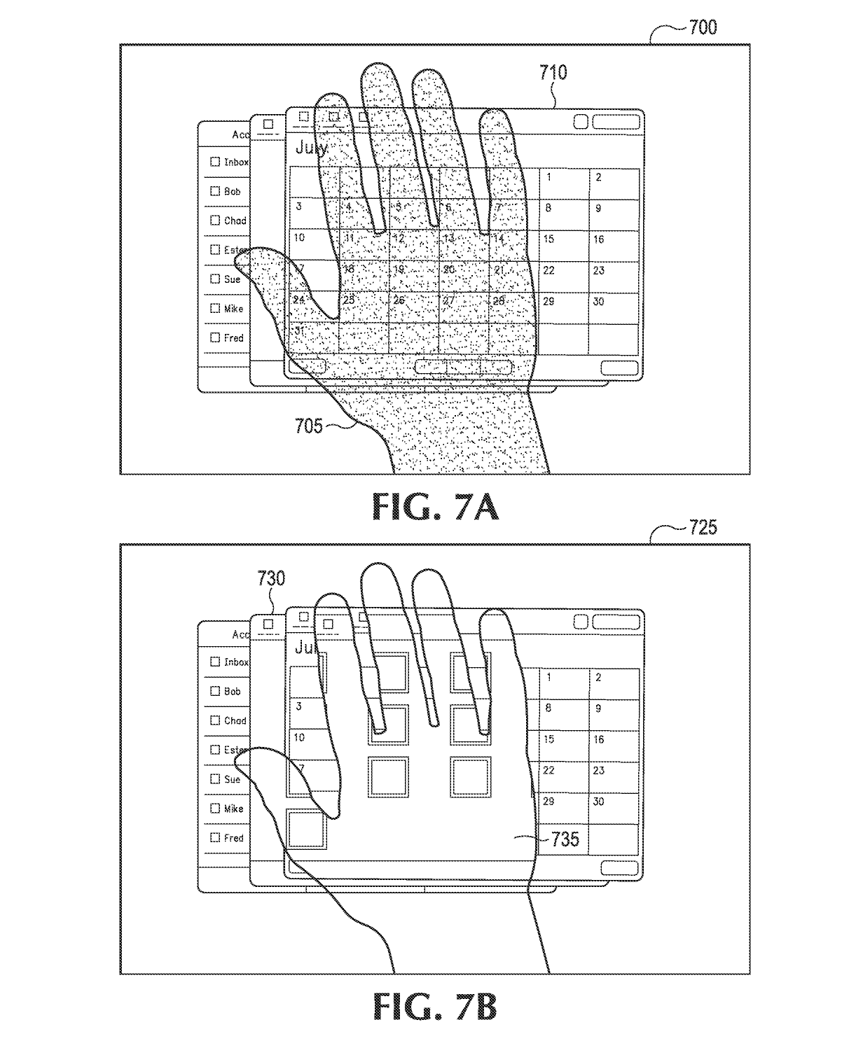

Modules 326, 328, 330 may also apply additional effects to the hand visualization prior to outputting the visualization. For example, when the touch interface is a multi-layered interface, regioning effect module 326 may apply a unique visualization to each section of the visualization that overlaps a different layer of the interface. For example, as illustrated in FIG. 6 and described in further detail below, regioning effect module 326 may first identify each portion of the visualization of the user's hand that intersects a given layer of the interface. Regioning effect module 326 may then apply a different shading, color, transparency, or other visual effect to the visualization of the hand within each intersected layer. In this manner, the visualization of the hand provides additional feedback to the user regarding the layers within the interface and allows a user to increase the accuracy of his or her touch gestures.

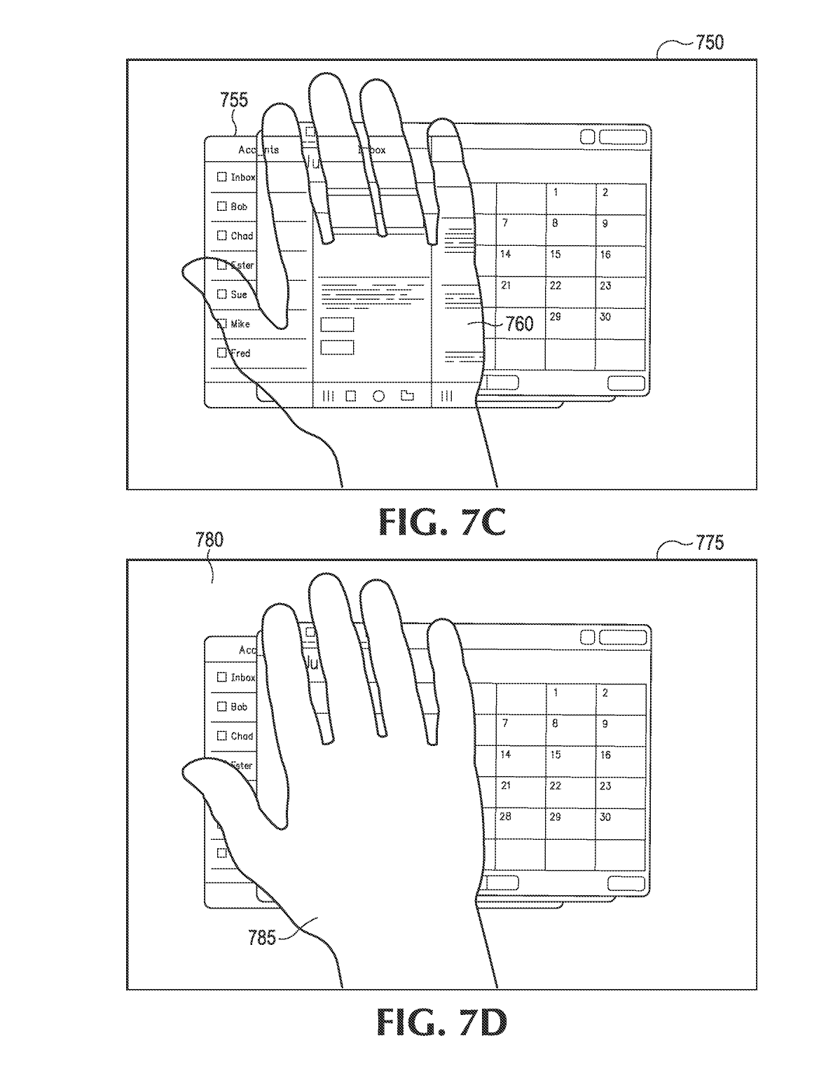

As an alternative to the regioning effect, revealing effect module 328 may apply an effect to change the visualization within the boundaries of the visualization of the user's hand. For example, as illustrated in FIGS. 7A-7D and described in further detail below, revealing effect module 328 may identify the currently-selected layer of the multi-layer user interface and display the current layer within the boundaries of the visualization of the user's hand. Because revealing effect module 328 may only apply the effect to the area within the boundaries of the user's hand, the top layer of the plurality of stacked layers may continue to be displayed outside of the boundaries of the user's hand. The revealing effect thereby enables the user to preview the content of a layer within the stack without moving that layer to the top of the stack.

Finally, physics effect module 330 may apply visual effects to the objects within the user interface based on collisions between the object and the real-time visualization of the user's hand and/or digits. Thus, physics effect module 330 may simulate physical interaction between the displayed objects and the user's hand. For example, physics effect module 330 may allow a user to flick, swipe, push, drag, bounce, or deform a displayed object by simply manipulating the object with the displayed hand visualization,

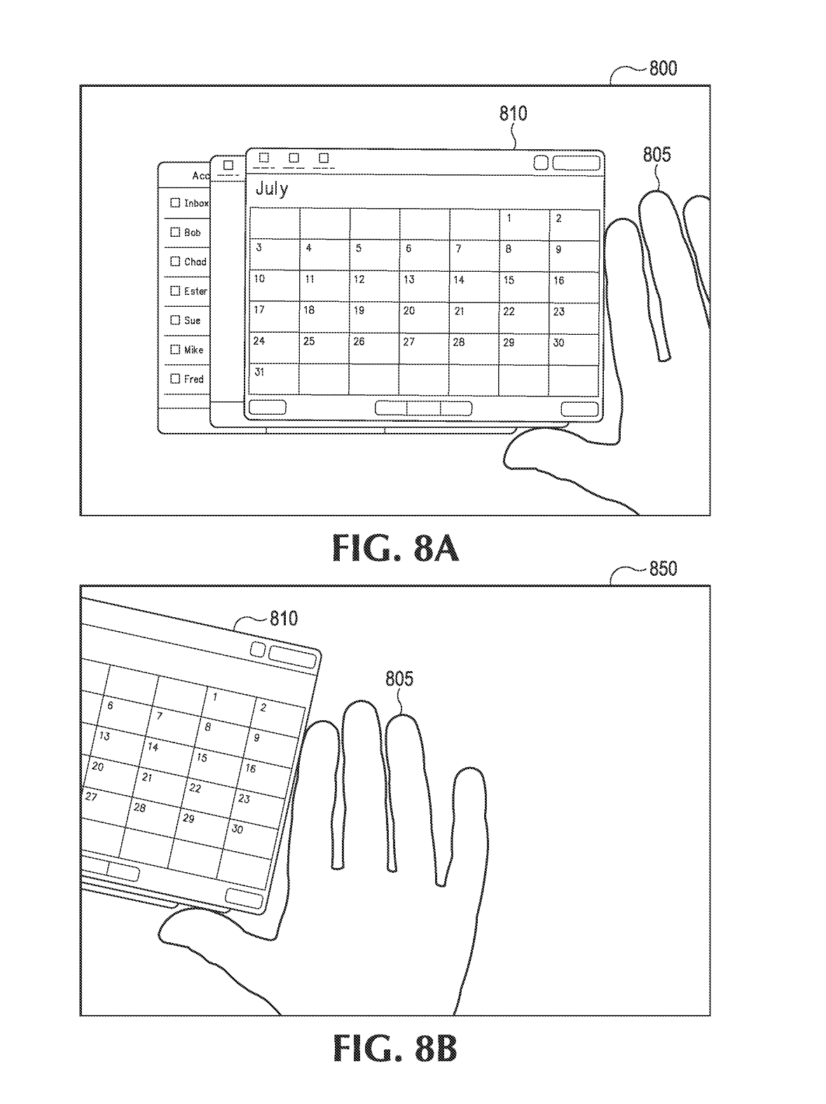

To implement these effects, physics effect module 330 may utilize a software and/or hardware physics engine. The engine may treat each displayed interface element and the hand visualization as a separate physical object and detect collisions between the interface elements and the hand visualization as the user moves his or her hand with respect to keyboard 350. For example, when the user moves his or her hand and the visualization collides with the edge of a window, physics effect module 330 may detect the collision and begin moving the window in the direction of the movement of the user's hand. As another example, when the user “grabs” a window using his or her thumb and index finger, physics effect module 330 may allow the user to deform the window, while pushing or pulling the window around the interface. An example of a physics effect applied to an object is illustrated in FIGS. 8A & 8B and described in further detail below.

Input processing module 335 may be configured to detect touch events and corresponding gestures and, in response, perform actions on objects displayed within the user interface. For example, as described in further detail above in connection with touch performing instructions 226, multi-touch gesture module 337 may initially detect touch events based on activation of one or more of touch keys 354 or application of pressure to the surface of keyboard 350. Touch keys 354 may be any keys on keyboard for which activation of the key represents a touch event. In some implementations, every key on keyboard 350 except for mode toggle key 352 and layer key(s) 356 may activate a touch event. Thus, the user may activate a single finger touch event by depressing one key of touch keys 354 and may similarly activate a multi-finger touch event by depressing multiple touch keys 354 simultaneously.

Upon detecting a touch event, multi-touch gesture module 337 may track the subsequent movement of the user's hand and/or digits to identify a gesture coupled with the touch event, as also described above in connection with performing instructions 226. Action performing module 339 may then perform an appropriate action on the user interface object with which the user has interacted. For example, when the user has performed a multi-touch gesture subsequent to the touch event, action performing module 339 may identify the object with which the user has interacted and perform a command corresponding to the multi-touch gesture on the object. To name a few examples, performing module 339 may zoom in, zoom out, scroll, dose, go back or forward, or otherwise control the displayed interface object. Additional details regarding the performed action are provided above in connection with performing instructions 226 of FIG. 2.

Keyboard 350 may be a physical keyboard suitable for receiving typed input from a user and providing the typed input to a computing device 305. As described above, the user may also interact with keyboard 350 to provide touch gestures to computing device 305 without interacting directly with display device 370. As described above with reference to input mode toggling module 307, mode toggle key 352 may allow a user to switch between multi-touch and keyboard modes. As described above with reference to input processing module 355, touch key(s) 354 may be used to trigger touch events by depressing one or more of the keys. Finally, as described above with reference to layer selection module 315, layer key(s) 356 allow the user to toggle the currently-displayed layer within a multi-layered touch interface.

As with sensor 240 of FIG. 2, sensor 360 may be any hardware device or combination of hardware devices suitable for detecting movement of a user's hands and digits along or above the top surface of keyboard 350. Thus, sensor 360 may be, for example, a wide-angle camera placed above keyboard 350 or, alternatively, a sensor included within, on the surface of, or below the keys of keyboard 350, such as a group of capacitive sensors, resistive sensors, or other sensors. Additionally, as with display device 250 of FIG. 2, display device 370 may be any hardware device suitable for receiving a video signal including a touch interface and a visualization of the user's hands from computing device 305 and outputting the video signal.

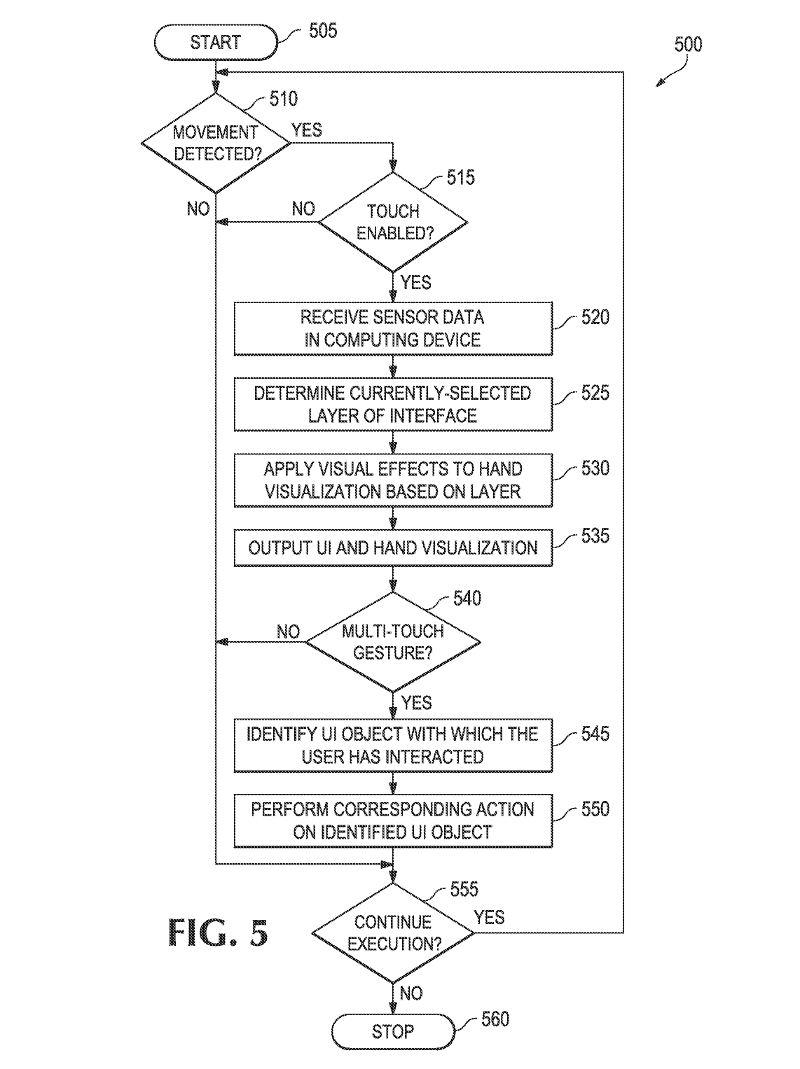

FIG. 4 is a flowchart of an example method 400 for receiving multi-touch input using a keyboard to thereby enable indirect manipulation of objects displayed in a multi-touch user interface. Although execution of method 400 is described below with reference to apparatus 200 of FIG. 2, other suitable devices for execution of method 400 will be apparent to those of skill in the art (e.g., apparatus 300). Method 400 may be implemented in the form of executable instructions stored on a machine-readable storage medium, such as storage medium 220, and/or in the form of electronic circuitry.

Method 400 may start in block 405 and proceed to block 410, where computing device 205 may receive information describing the movement of the user's hand from sensor 240. For example, computing device 205 may receive data from sensor 240 including a video or other image of the user's hands and indicating the relative position of the user's hands on or above keyboard 230.

Next, in block 415, computing device 205 may use the received sensor data to generate and output a real-time visualization of the user's hands on display device 250. The visualization may be overlaid on top of the multi-touch interface and may be outputted at a position corresponding in location to the relative position of the user's hands with respect to keyboard 230. In addition, computing device 205 may update the visualization in real-time as the user moves his or her hands along or above the surface of keyboard 230.

Finally, in block 420, computing device 205 may detect and perform a multi-touch command on an object selected by the user using the hand visualization. In particular, computing device 205 may first detect the occurrence of a multi-touch event, such as two or more key presses or application of pressure to two or more points on the surface of keyboard 230. Computing device 205 may then identify the user interface object with which the user has interacted based on the position of the corresponding digits within the mufti-touch interface. Finally, computing device 205 may track movement of the user's digits subsequent to initiation of the touch event and perform a corresponding multi-touch action on the identified object. Method 400 may then proceed to block 425, where method 400 may stop.

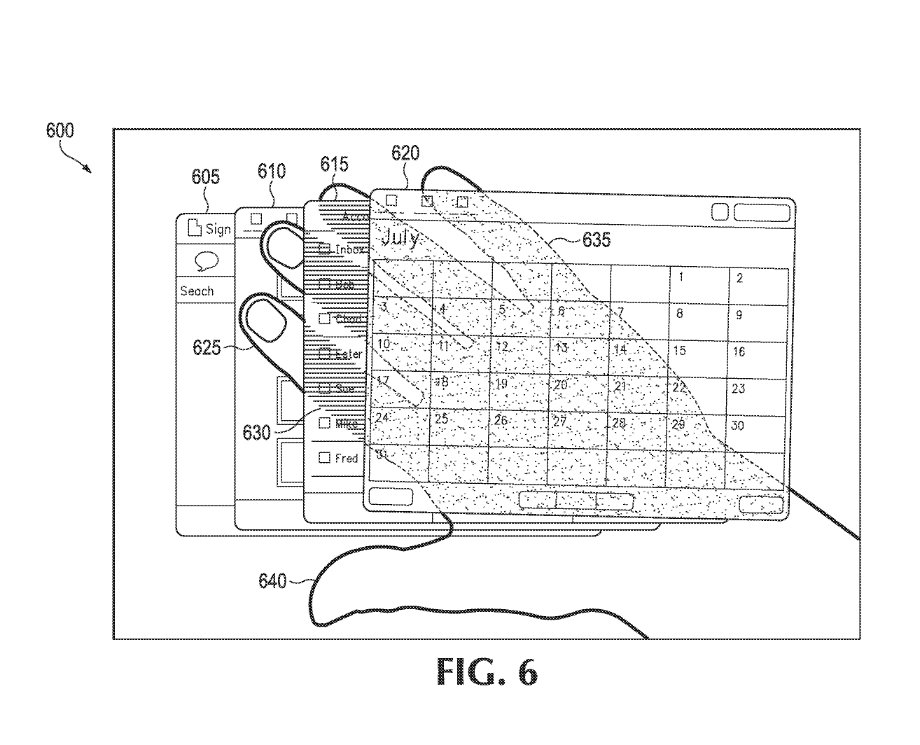

FIG. 5 is a flowchart of an example method 500 for receiving mufti-touch input using a keyboard to interact with a multi-layered touch user interface. Although execution of method 500 is described below with reference to apparatus 300 of FIG. 3, other suitable devices for execution of method 500 will be apparent to those of skill in the art, Method 500 may be implemented in the form of executable instructions stored on a machine-readable storage medium and/or in the form of electronic circuitry.

Method 500 may start in block 505 and proceed to block 510, where sensor 360 may determine whether the user has moved his or her hand along or above the top surface of keyboard 350. When sensor 360 does not detect movement of the user's hand, method 500 may continue to block 555, described in detail below. Otherwise, when sensor 360 detects movement, computing device 305 may then determine in block 515 whether mufti-touch mode is enabled. For example, computing device 305 may determine whether the user has selected mufti-touch mode or keyboard-only mode using mode toggle key 352. When computing device 305 is in keyboard-only mode, computing device 305 may ignore the movement of the user's hand and method 500 may proceed to block 555,

On the other hand, when multi-touch mode is enabled, method 500 may continue to block 520, where sensor 360 may provide sensor data to computing device 305. As detailed above, the sensor data may be, for example, a video stream or other stream of image data describing the position and orientation of the user's hands with respect to keyboard 350.

Next, in block 525, computing device 305 may determine the currently-selected layer within the multi-layered user interface to be outputted by computing device 305. For example, the user interface may include a plurality of stacked interface elements, such as windows or cards. Computing device 305 may allow the user to navigate between the layers using layer key(s) 356, based on the distance of the user's hand from keyboard 350, or based on the speed of movement of the user's hand.

After determination of the current layer in block 525, method 500 may continue to block 530, where computing device 305 may generate a hand visualization and apply any visual effects to the visualization. For example, computing device 305 may use the sensor data received in block 520 to generate a real-Lime visualization of the user's hand and to determine an appropriate location for the visualization within the multi-touch user interface. Computing device 305 may then apply one or more visual effects to the visualization based on the currently-selected layer. For example, computing device 305 may apply a regioning effect to change the appearance of portions of the visualization to clearly delineate the overlap of the visualization with each layer of the interface. As another example, computing device 305 may apply a revealing effect to display the currently-selected layer of the interface within the boundaries of the hand visualization. The regioning and revealing effects are described in further detail above in connection with modules 326 and 328 of FIG. 3, respectively.

After generating the hand visualization with any effects, computing device 305 may then output the user interface and hand visualization in block 535. Thus, computing device 305 may output the multi-touch user interface on display device 370 and output the hand visualization overlaid on top of the interface. In this manner, the user may simultaneously view a simulated image of his or her hand and the underlying multi-touch interface.

Next, after outputting the interface and hand visualization, computing device 305 may begin monitoring for touch events and corresponding multi-touch gestures. For example, computing device 305 may detect a multi-touch event based on activation of multiple touch keys 354 or application of pressure at multiple points of the surface of keyboard 350. Computing device 305 may then track movement of the user's digits from the points of activation to monitor for a predetermined movement pattern that identifies a particular multi-touch gesture.

When computing device 305 does not detect a touch event and a corresponding multi-touch gesture, method 500 may continue to block 555, described in detail below. Alternatively, when computing device 305 detects a multi-touch gesture, method 500 may then proceed to block 545, where computing device 305 may identify the user interface object with which the user has interacted. For example, computing device 305 may identify the object at the location in the user interface at which the user's digits were positioned when the user initiated the multi-touch gesture. In block 550, computing device 305 may perform an action on the identified object that corresponds to the performed multi-touch gesture, such as zooming, scrolling, or performing another operation.

In block 555, computing device 305 may determine whether to proceed with execution of the method. For example, provided that computing device 305 remains powered on and the keyboard-based touch software is executing, method 500 may return to block 510, where computing device 305 may continue to monitor and process multi-touch input provided by the user via keyboard 350. Alternatively, method 500 may proceed to block 560, where method 500 may stop.

FIG. 6 is a diagram of an example interface 600 applying a regioning effect to a visualization of a user's hand. Example interface 600 may be generated based, for example, on execution of the functionality provided by regioning effect module 326, which is described further above in connection with FIG. 3.

Regioning effect module 326 may initially identify a plurality of portions 625, 630, 635, 640 of the hand visualization that intersect the various layers 605, 610, 615, 620 of the user interface. Referring to interface 600, regioning effect module 326 has identified portion 625 of the visualization as overlapping card 610 of interface 600, portion 630 as overlapping card 615, portion 635 as overlapping card 620, and portion 640 as not overlapping any of the cards.

Regioning effect module 326 may then apply a unique pattern to each portion of the representation of the user's hand. Thus, in the example of FIG. 6, regioning effect module 326 has utilized a video representation of the user's fingertips in portion 625, a striped pattern in portion 630, transparent shading in portion 635, and complete transparency in portion 640. It should be noted that other types of visualizations may be used to distinguish the portions. For example, the portions may be visualized based on the use of different colors, shading patterns, transparencies, textures, and/or other visual features. As a result, the user can quickly identify the location of his or her fingers within the virtual interface based on the different visualizations applied to each portion 625, 630, 635, 640.

FIGS. 7A-7D are diagrams of example interfaces 700, 725, 750, 775 applying a revealing effect to a visualization of a user's hand. Example interface 700 may be generated based, for example, on execution of the functionality provided by revealing effect module 328, which is described further above in connection with FIG. 3. Thus, revealing effect module 328 may initially determine which layer of a multi-layer interface the user has currently selected using layer key(s) 356 or any technique for specifying a current layer. Revealing effect module 328 may then display the currently-selected layer within the boundaries of the visualization of the user's hand, while displaying the top layer outside of the boundaries of the visualization.

Referring to interface 700 of FIG. 7A, the user has selected layer 710, which is a card currently displaying a calendar application. As illustrated, revealing effect module 328 has displayed the calendar application within the boundaries of hand visualization 705, which is currently filled using transparent shading. Furthermore, the topmost layer is displayed outside of hand visualization 705, which, in this case, also includes layer 710.

Referring now to interface 725 of FIG. 7B, the user has selected the next layer down, layer 730, which is a card displaying a photo viewing application. As illustrated, revealing effect module 328 has displayed a preview of the photo viewing application within the boundaries of hand visualization 735. In contrast, the topmost layer, the calendar application, continues to be displayed outside of the boundaries of hand visualization 735.

Similar effects are visible in interface 750 of FIG. 7C and interface 775 of FIG. 7D. More specifically, in FIG. 7C, revealing effect module 328 has displayed layer 755, an email application, within the boundaries of hand visualization 760. Finally, in FIG. 7D, revealing effect module 328 has displayed the bottommost layer, desktop 780, within the boundaries of hand visualization 785.

FIGS. 8A & 8B are diagrams of example interfaces 800, 850 applying physics effects to user interface elements based on collisions with a visualization of a user's hand. As described above in connection with FIG. 3, physics effect module 330 may be configured to detect collisions between the user's hand and user interface objects and, in response, display effects simulating physical interaction between the hand and the objects.

Thus, in interface 800 of FIG. 8A, the user has moved his or her right hand to a right portion of keyboard 350, such that the hand visualization 805 is displayed on the right side of interface 800. Furthermore, as illustrated, the user's thumb and index finger are positioned on the edge of stack 810, which includes three stacked cards, each displaying an application.

As illustrated in interface 850 of FIG. 8B, the user has moved his or her right hand toward the center of keyboard 350, such that the visualization 805 of the user's hand has also moved toward the center of interface 850. In addition, physics effect module 330 has detected the collision between the thumb and index finger of hand 805 and the right and bottom edges of stack 810. In response, physics effect module 330 has applied the movement of hand 805 to stack 810 and therefore pushed stack 810 to the edge of screen. Continued movement of stack 810 by the user would be sufficient to push stack 810 from the screen and thereby close the applications within the stack. Note that, as described above in connection with FIG. 3, physics effect module 330 may apply numerous other effects, such as dragging, bouncing, and deforming displayed objects.

The foregoing disclosure describes a number of example embodiments for enabling a user to control a multi-touch user interface using a physical keyboard. In particular, example embodiments utilize a sensor to track movement of a user's hands and digits, such that the user may fully interact with a multi-touch interface using the keyboard. Furthermore, because some embodiments allow for navigation between layers of a touch interface, the user may seamlessly interact with a complex, multi-layered touch interface using the keyboard. Additional embodiments and advantages of such embodiments will be apparent to those of skill in the art upon reading and understanding the foregoing description.

We claim:

1. An apparatus comprising:
a keyboard;
a sensor for detecting movement of a user's digits in a direction parallel to a top surface of the keyboard;
a display device; and
a processor to:
receive information describing the movement of the user's digits from the sensor,
output a real-time visualization of the user's digits on the display device, the visualization overlaid on a multi-touch user interface including a displayed object, and
perform a multi-touch command on the displayed object based on the movement of the user's digits detected by the sensor.

2. The apparatus of claim 1, wherein the sensor comprises one or more of a camera placed above the top surface of the keyboard, a capacitive touch sensor, an infrared sensor, and an electric field sensor.

3. The apparatus of claim 2, wherein, when the sensor includes a camera, the processor outputs the real-time visualization of the user's digits as a video representation of the user's hand obtained by the camera.

4. The apparatus of claim 1, wherein the sensor is a camera mounted to a top surface of the keyboard.

5. The apparatus of claim 4, wherein the camera is mounted to a boom movable between an extended position and a retracted position.

6. The apparatus of claim 1, wherein the processor is additionally to:
detect a predetermined input for switching between a multi-touch mode and a keyboard-only mode, and
toggle display of the real-time visualization of the user's digits in response to switching between the multi-touch mode and the keyboard-only mode.

7. The apparatus of claim 1, wherein:
the multi-touch user interface includes windows in a plurality of stacked layers, and
the processor is additionally to update the multi-touch user interface to display a window of a currently-selected layer in a foreground of the interface based on a position of the real-time visualization within the plurality of stacked layers.

8. The apparatus of claim 7, wherein the processor is additionally to:
modify the currently-selected layer of the plurality of stacked layers based on user selection of one or more predetermined keys on the keyboard.

9. The apparatus of claim 7, wherein the processor is additionally to:
modify the currently-selected layer of the plurality of stacked layers based on a distance of the user's digits from the top surface of the keyboard.

10. The apparatus of claim 7, wherein the processor is additionally to:
modify the currently-selected layer of the plurality of stacked layers based on a speed of the movement of the user's digits in the direction parallel to the top surface of the keyboard.

11. The apparatus of claim 7, wherein, in outputting the real-time visualization, the processor is additionally to:
identify a plurality of portions of the real-time visualization of the user's digits, each portion intersecting a respective layer of the plurality of stacked layers, and
apply a unique visualization to each identified portion of the plurality of portions of the real-time visualization.

12. The apparatus of claim 7, wherein, the processor is additionally to:
display the currently-selected layer in the foreground of the interface within the boundaries of the real-time visualization of the user's digits, and
display a top layer of the plurality of stacked layers in the foreground of the interface outside of the boundaries of the real-time visualization of the user's digits.

13. The apparatus of claim 1, wherein the processor is additionally to:
simulate physical interaction between the displayed object and the user's digits by applying a physics effect to the displayed object based on a collision between the displayed object and the real-time visualization of the user's digits.

14. The apparatus of claim 13, wherein the physics effect comprises one or more of flicking the displayed object, swiping the displayed object, pushing the displayed object, dragging the displayed object, bouncing the displayed object, and deforming the displayed object.

15. A machine-readable storage medium encoded with instructions executable by a processor of a computing device for enabling multi-touch user interaction with a keyboard, the machine-readable storage medium comprising:
instructions for receiving data from a sensor that detects movement of a user's hand on or above a top surface of the keyboard;
instructions for displaying a representation of the user's hand on a display of the computing device overlaid on an existing touch interface, the representation updating in real-time as the user moves the hand;
instructions for identifying, in response to a multi-touch gesture of the user's digits, an object displayed in the touch interface with which the user has interacted; and
instructions for performing an action corresponding to the multi-touch gesture on the object with which the user has interacted.

16. The machine-readable storage medium of claim 15, wherein:
the touch interface includes windows in a plurality of stacked layers, and
the instructions for displaying are configured to update the touch interface to display a window of a currently-selected layer in a foreground of the interface based on a position of the representation of the user's hand within the plurality of stacked layers.

17. The machine-readable storage medium of claim 16, further comprising:
instructions for receiving a user selection of a current layer to be displayed in the foreground, the instructions receiving the user selection based on one or more of:
user activation of one or more predetermined keys on the keyboard,
a distance of the user's hand from the top surface of the keyboard, and
a speed of the movement of the user's hand parallel to the top surface of the keyboard.

18. A method for enabling indirect manipulation of objects displayed in a multi-touch user interface using a keyboard in communication with a computing device, the method comprising:
using a sensor to detect movement of a user's hand in a direction parallel to a top surface of the keyboard;
displaying a representation of the user's hand on a display of the computing device overlaid on a touch interface including a plurality of layers, the representation of the user's hand updating in real-time as the user moves the hand;
displaying a current layer of the plurality of layers in a foreground of the touch interface in response to a user selection of the current layer; and
performing a mufti-touch gesture on an object in the current layer with which the user has interacted using the representation of the user's hand.

19. The method of claim 18, wherein:
the sensor is a wide-angle camera placed above the top surface of the keyboard, and
displaying the representation of the user's hand comprises:
normalizing a video representation of the user's hand captured by the wide-angle camera to reverse a wide angle effect of the camera,
shifting a perspective of the normalized video representation to a perspective directly above the user's hand, and
displaying the normalized and shifted video representation of the user's hand.

20. The method of claim 18, wherein the representation of the user's hand is a transparent image overlaid on the touch interface.
